(19) United States
(12) Patent Application Publication
(10) Pub. No.: US 2007/0258751 A1
(43) Pub. Date: Nov. 8, 2007

(54) Writing instrument with recessed portion and abrasive surface

(76) Inventor: John O'Hern, Hoboken, NJ (US)

Correspondence Address: FROMMER LAWRENCE & HAUG, 745 FIFTH AVENUE- 10TH FL., NEW YORK, NY, 10151, US

(21) Appl. No.: 11/416,735

(22) Filed: May 3, 2006

(51) Int. Cl. B43K 29/00; B43K 25/00

(52) U.S. Cl. 401/195; 401/52

(57) ABSTRACT

A writing instrument with a recessed portion is provided in which an abrasive surface is fitted. The abrasive surface, when installed, provides the writing instrument with a nail shaping surface along the length of the recessed portion. The abrasive surface may have one or more grades of abrasiveness and the writing instrument and abrasive surface may be a variety of configurations, including, but not limited to, circular or three, four, or five sided.

### FIELD OF THE INVENTION

The present invention relates to a writing instrument with a recessed portion, wherein one or more abrasive surfaces are installed in the recessed portion.

### BACKGROUND DISCUSSION

There are various implements that are used for shaping finger nails, many of which are simply nail files and have no other useful purpose. As such, those devices are simply carried and used by themselves. On the other hand, there are other devices that have been disclosed and which are combination devices such that the device not only comprises a nail file but may also have an additional purpose. Such combination devices are of an added convenience to the user, particularly if the other use of the device is also a use that would normally entail a device that is carried on one's person such as, for example, in a woman's purse.

Accordingly such combination devices can be employed to combine two or more functions in a single device. One of such combination device combines the functions of a writing instrument while also providing the convenience and utility of being usable for shaping nails, that is, of being used as a nail file.

One such device that is a combination of a writing instrument and a nail shaping device is U.S. Pat. No. 6,572,299 to Brennan (hereinafter, merely “Brennan”). Brennan discloses a writing instrument in which an abrasive strip or strips is formed substantially along the length of the main body of the writing instrument. Brennan also discloses that abrasive strips can be located in slots that are formed along the main body of the writing instrument. There are two drawbacks to the slotted design of Brennan. First, in terms of production, the slotting process is complicated and costly. Second, the slotted files are not user-friendly, because they are of limited surface area.

Another example of a device that combines the functions of a writing instrument and a nail shaping device is shown and described in U.S. Pat. No. 5,090,427 of Sherts (hereinafter, merely “Sherts”). The Sherts patent discloses a writing instrument that includes a means for pushing back the cuticle of the finger as well as having an abrasive strip that can be used for shaping of fingernails. One disadvantage of the Sherts device, however, lies in the location of the cuticle pusher and the abrasive strip. Both functions are located on the cap of the writing instrument and, as such, the cap may become disengaged from the main body of the instrument during use or, alternatively, can be disengaged to carry out its fingernail shaping function and inadvertently misplaced so that the cap is not replaced on the body of the writing instrument. Furthermore, the overall length of the strip of abrasive material, being confined to the cap of the writing instrument, is limited and, as such, the user cannot get a full stroke or full effective use of the nail shaping function.

In additional combination devices of the type discussed, there has also been disclosed, a clip attachment for a pocket carried device, such as a pen in U.S. Pat. No. 1,478,049. However, again, the length of the abrasive surface usable to carry out the shaping of a fingernail is limited due to the physical dimensions of a clip employed with a pen and its alternate function of clipping the pen to the pocket of a user.

Other examples of such combination devices that have also been disclosed include Design Pat. No. 257,181 to Brown and U.S. Pat. No. 2,841,156 of Herald, both of which devices are also limited in overall length since they also rely on the clip of a pen for the location of the abrasive strip and thus suffer from the same drawbacks as the previously discussed combination devices. In addition, of course, such constructions severely limit the width of the strip of abrasive material that can be associated with the clips used with pens.

In addition to the problem or deficiency of the aforedescribed prior art devices, relative to the limited length of the abrasive strip, by utilizing the clip, cap, slot, or other relatively small component of the writing instrument, the device is limited in the width of the abrasive material and cannot physically provide more than one, or two in the case of the slot, relatively narrow strip(s) of such material. Thus, with any of these combination devices, it would not be practical to include more than one strip of the abrasive material, such as would be advantageous of a user desiring more the one abrasive strip so as to have differing grades of abrasiveness, that is, if a user were to desire a device having one strip of a material that is a coarse abrasive and a second strip of a material with a finer abrasiveness on the same writing instrument.

It would therefore be advantageous to have a writing instrument that can be used with a longer and wider surface or strip of abrasive material, but in addition, can have the capability, dimensionally, to provide more than one abrasive surface with differing grades of abrasive materials so that the user can have additional flexibility and functionality in utilizing the nail shaping function while not detracting from the writing capability of the writing instrument.

### SUMMARY OF THE INVENTION

The present invention provides a writing instruments fitted with a nail shaping function that overcomes the problems and deficiencies of the aforedescribed prior art combination devices. Thus, in accordance with the present invention, a writing instrument is provided with a recessed portion on the body of the pen to accommodate one or more abrasive surfaces. The recessed portion can be of any length and width, and can be on all sides of the body, or on just some of the sides. The writing instrument comprises a main body having an external surface, wherein said main body has a proximal end and a distal end having a writing point, a portion towards the distal end that a user grips when using the writing instrument for writing, and a portion towards the proximal end that is recessed; and an abrasive surface fitted in the recessed portion of the main body.

The abrasive surface of the present invention, provides the writing instrument with a nail shaping function along the length of the tubular body. Therefore, the abrasive surface can be extended in length over those uses where the abrasive strip is oriented on the clip or cap of the writing instrument.

The present invention also provides a method of making a writing instrument comprising the steps of providing a writing instrument having a main body having an external surface, wherein said main body has a proximal end and a distal end having a writing point, a portion towards the distal end that a user grips when using the writing instrument for writing, and a portion towards the proximal end that is recessed, and fitting an abrasive surface in the recessed portion of the main body.

In one embodiment, the abrasive surface and the external surface of the main body may be flush. Furthermore, the abrasive surface may be secured to the recessed portion of the main body with adhesive or another process. The abrasive surface may comprise one or more grades of abrasiveness.

In another embodiment, the present invention provides a writing instrument kit comprising, as a first component, a main body having a external surface, wherein said main body has a proximal end and a distal end having a writing point, a portion towards the distal end that a user grips when using the writing instrument for writing, and a portion towards the proximal end that is recessed, as a second component, an abrasive surface capable of being fitted in the recessed portion of the main body.

Furthermore, the writing instrument kit may comprise an abrasive surface with a thickness that is equal to a depth of the recessed portion of the main body. Furthermore, an adhesive may be provided to secure the abrasive surface to the recessed portion of the main body. The abrasive surface may also comprise one or more grades of abrasiveness.

Other features of the writing instrument will become apparent in light of the following detailed description of a preferred embodiment thereof and as illustrated in the accompanying drawings.

### BRIEF DESCRIPTION OF THE DRAWINGS

FIG. 1 is a perspective view of a writing instrument with a recessed portion in accordance with the present invention; and

FIG. 2 is a perspective view of the abrasive surface installed on the writing instrument;

### DETAILED DESCRIPTION OF THE INVENTION

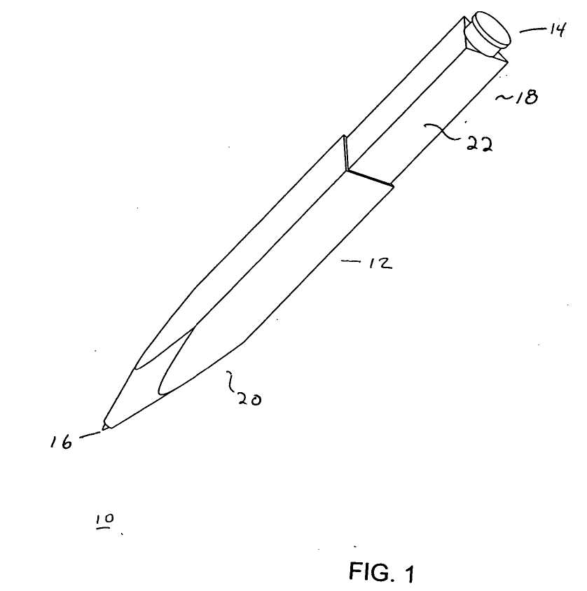

FIG. 1 shows a perspective view of a writing instrument with a recessed portion in accordance with the present invention. In the embodiment of FIG. 1, the writing instrument 10 comprises a main body 12 having a predetermined external surface having a triangular configuration. As is normal with such instruments, the writing substance is located within the main body of the instrument and can be pencil lead, a normal liquid ink, or an ink cartridge for a ball point pen. This embodiment is typical of a ball point pen and therefore includes a button 14 located on the writing instrument 10 in order to operate the device and to move the point 16 of the ball point cartridge contained within the main body 12 from an exposed position as shown in FIG. 1 to a retracted position as is conventional with such writing instruments 10. Accordingly, although a ball point pen embodiment is shown and described hereinafter with respect to FIG. 1, it will be seen that the writing instrument 10 may be any other type of similar writing instrument 10, including, but not limited to, fountain pen, a pencil, or other device.

As will also be referenced, the top end of the writing instrument 10 will be referred to as the proximal end 18. And where the end of the writing instrument 10 that contacts the material for writing thereon, and where the point 16 is located will be referred to as the distal end 20. The distal end 20 narrows down in the direction of the point 16 and may become generally circular in cross section in order to be more convenient and comfortable for the user to properly grip the writing instrument 10.

The main body 12 of the writing instrument 10 has an exterior surface that can also be of a variety of configurations, including square, rectangular, oval, round or other geometrical or non-geometrical shapes.

As shown in FIG. 1, the recessed portion 22 is located toward the proximal end 18 of the main body 12. As shown in FIG. 1, the main body 12 and the recessed portion 22 of the main body have a triangular configuration. However, in another embodiment, the recessed portion 22 may have a dissimilar configuration than the main body 12.

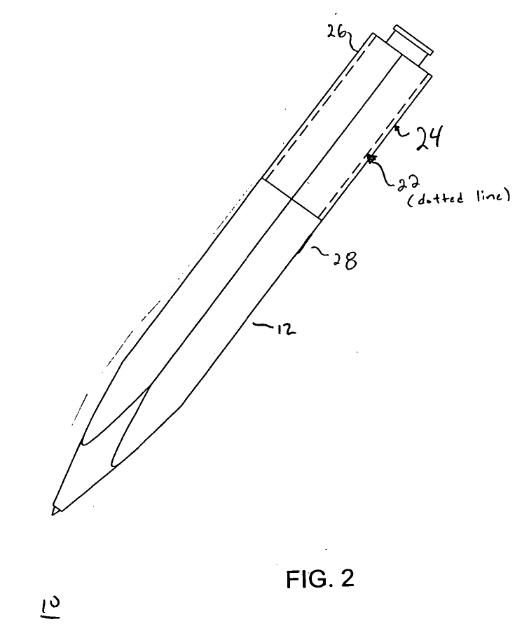

FIG. 2 shows the abrasive surface 24 installed on the recessed portion of the main body 12 of the writing instrument 10. When the abrasive surface 11 is installed, the abrasive surface 24 and the exterior surface 28 of the writing instrument 10 may be flush. However, the abrasive surface 24 may be any thickness and the recessed portion 22 of the main body 12 may be any depth. The interior surface 28 of the abrasive surface 24 and the surface of the recessed portion 22 of the writing instrument 10 may both be textured, or smooth.

As shown in FIG. 2, the abrasive surface 24 is also triangular and the entire surface is abrasive. However, the abrasive surface 24 may be any shape, including circular, three sided, and five sided, and may have an abrasive surface located on any or all of the surfaces.

In one embodiment, an abrasive surface 24 may be installed on each side of the main body 12. However, in the case of a square external configuration, there may be two abrasive surfaces. Two contiguous sides will have one grade of abrasive surface and the remaining two sides will have a different grade of abrasive material. In one embodiment there at least two abrasive surfaces installed on the recessed portion 22 of the main body, and there may be a non-abrasive surface 26 located intermediate each of the abrasive surfaces to separate those strips for the convenience in using the writing instrument 10 for the shaping of the fingernails.

The actual material used for the abrasive surface 24 may be emery as is currently used in nail files and the like.

Where two or more abrasive surfaces are installed, the individual surfaces may have differing grades of abrasiveness. For example, one of the surfaces may have a coarse abrasive material while the other surface may be comprised of a finer abrasive material so that the user can initially shape the fingernail with the coarser material and finish the shaping of the fingernail with the finer abrasive material.

The abrasive surface 24 itself, can be provided in the form of a strip that is affixed to the recessed portion 22 of the main body 12 by means of an adhesive or can be molded or pressed into the external plastic or other material of the recessed portion 22 of the main body 12 and thus embedded into that external surface. As a further embodiment, the strip of abrasive material may be separately provided and slipped into a special formed external slotted surface on the external surface thereof, and then further affixed thereto by an adhesive.

The abrasive surface 24 may be easily installed or removed, and can be replaced quickly. For example, the writing instrument 10 and the abrasive surface 24 can be separated if an abrasive surface 24 is worn or the writing instrument 10 runs out of ink.

For permanent installation, the abrasive surface 24 may be adhered, by gluing the abrasive surface to the main body 12. Thus, the abrasive surface 24 and main body 12 can be a writing instrument kit.

As can be seen, by installing the abrasive surface 24 on or along substantially the entire length of the main body 12 of the writing instrument 10 by, the user has a better grip on the writing instrument 10 to properly shape the fingernails without of the abrasive surface 24 coming loose, being misplaced and the like and also has the further advantage, as shown, that the use of the full, main body 12 also comprises the additional surface area of the external surface of the writing instrument 10 so as to enable the user the potential of a plurality of strips of abrasive material.

While illustrative embodiments of the invention have been described above, it is, of course, understood that various modifications will be apparent to those of ordinary skill in the art. Such modifications are within the spirit and scope of the invention, which is limited and defined only by the appended claims.

What is claimed is:

1. A writing instrument comprising:
a main body having an external surface,
wherein said main body has a proximal end and a distal end having a writing point, a portion towards the distal end that a user grips when using the writing instrument for writing, and a portion towards the proximal end that is recessed; and
an abrasive surface fitted in the recessed portion of the main body.

2. The writing instrument of claim 1 wherein the abrasive surface and the external surface of the main body are flush.

3. The writing instrument of claim 1 wherein the abrasive surface is secured to the recessed portion of the main body with adhesive.

4. The writing instrument of claim 1 wherein the abrasive surface comprises one or more grades of abrasiveness

5. A method of making a writing instrument comprising the steps of:
providing a writing instrument having a main body having an external surface,
wherein said main body has a proximal end and a distal end having a writing point, a portion towards the distal end that a user grips when using the writing instrument for writing, and a portion towards the proximal end that is recessed; and
fitting an abrasive surface in the recessed portion of the main body.

6. The method of making a writing instrument as defined in claim 5 further comprising:
securing the recessed portion of the main body with adhesive.

7. The method of making a writing instrument as defined in claim 5 wherein the abrasive surface and the external surface of the main body are flush.

8. The method of making a writing instrument as defined in claim 4 wherein the abrasive surface comprises one or more grades of abrasiveness.

9. A writing instrument kit comprising:
as a first component, a main body having a external surface,
wherein said main body has a proximal end and a distal end having a writing point, a portion towards the distal end that a user grips when using the writing instrument for writing, and a portion towards the proximal end that is recessed;
as a second component, an abrasive surface capable of being fitted in the recessed portion of the main body.

10. The writing instrument kit of claim 9 wherein a thickness of the abrasive surface is equal to a depth of the recessed portion of the main body.

11. The writing instrument kit of claim 9 further comprising adhesive for securing the abrasive surface to the recessed portion of the main body.

12. The writing instrument kit of claim 9 wherein the abrasive surface comprises one or more grades of abrasiveness.
